(19) United States
(12) Patent Application Publication
(10) Pub. No.: US 2011/0276398 A1
(43) Pub. Date: Nov. 10, 2011

(54) Method for providing location aware social network service advertisements

(75) Inventor: Jeng Yen Peng, Sindian City (TW)

(73) Assignee: Leadtek Research Inc.

(21) Appl. No.: 12/662,880

(22) Filed: May 10, 2010

(51) Int. Cl. G06Q 30/00; G06Q 50/00; G06Q 99/00

(52) U.S. Cl. 705/14.53

(57) ABSTRACT

A method for providing location aware social network service advertisements comprises the steps of: receiving a post request via a mobile network, wherein the post request comprises location-related information; responding to the post request by creating a web post on a social network website; receiving an inquiring request of the web post; aggregating location-related advertisements corresponding to the content of the web post and the location-related information; and dynamically creating a web page that combines the content of the web post and the aggregated advertisements.

### BACKGROUND OF THE INVENTION

1. Field of the Invention

The present invention relates to a method for providing advertisements, and more particularly, to a method for providing location aware social network advertisements.

2. Description of the Related Art

Mobile advertising is an advertising approach targeted at mobile communication device users, e.g. mobile phone users. Some typical mobile advertisements include short messaging service (SMS) or multimedia messaging service (MMS) mobile advertisements, which may be a coupon or discount information. Because mobile communication devices have high penetration worldwide, mobile advertising is on the verge of going mainstream as an important way for advertisers to communicate with consumers. Accordingly, service operators and advertising agencies are all looking for new ways of monetizing the provided services and new revenue sources.

Social network service, another newly developed and promising application, provides the service of building a social network among users who become members of the social network. Most social network services are web based and provide means for users to communicate via the Internet. Typically, social network websites allow users to share ideas, activities or events with other social network members. Some successful social network services include Facebook, Twitter and Plurk.

Social network service advertising, which some people relate closely to mobile advertising, is another new advertising approach targeted at social network members. Social network service advertising has the advantage of offer advertisers the opportunity to target their advertisement according to users' demographic information. For example, advertisers can promote certain merchandise based on a user's hobby or recent event. Another advantage is that advertisers can inform a user that his or her friend, who is also a member of the social network, recently bought some particular merchandise.

Therefore, both mobile advertising and social network service advertising are promising and powerful advertising approaches compared with traditional advertising approaches. However, currently there is no method combining the advantages of these two advanced advertising approaches. The present invention provides such a method.

### SUMMARY OF THE INVENTION

The present invention provides a method for transmitting advertisements to a communication device that combines the advantages of mobile advertising and social network advertising. The user of a mobile communication device acts as an advertisement promoter by delivering a post request. A social network website acts as an advertisement channel serving as a gateway to advertisement consumers. A content aggregating apparatus acts as content aggregator and advertisement publisher. Members of the social network website act as advertisement consumers who read the advertisements on a created web page.

The method for providing location aware social network service advertisements according to one embodiment of the present invention comprises the steps of: receiving a post request via a mobile network, wherein the post request comprises location-related information; responding to the post request by creating a web post on a social network website; receiving an inquiring request of the web post; aggregating location-related advertisements corresponding to the content of the web post and the location-related information; and dynamically creating a web page that combines the content of the web post and the aggregated advertisements.

### BRIEF DESCRIPTION OF THE DRAWINGS

The objectives and advantages of the present invention will become apparent upon reading the following description and upon referring to the accompanying drawings of which:

FIG. 1 shows a system of providing location aware social network service advertisements according to one embodiment of the present invention;

FIG. 2 shows a flow chart of a method for providing location aware social network service advertisements according to one embodiment of the present invention;

FIG. 3 shows a flow for providing location aware social network service advertisements according to one embodiment of the present invention;

FIG. 4 shows a web post according to one embodiment of the present invention; and

FIG. 5 shows a created web page according to one embodiment of the present invention.

### DETAILED DESCRIPTION OF THE INVENTION

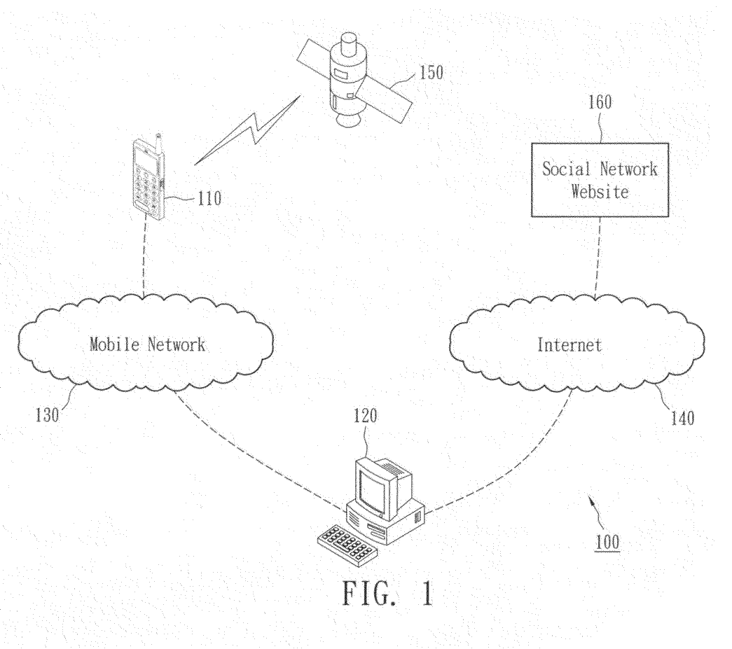

FIG. 1 shows a system of providing location aware social network service advertisements according to one embodiment of the present invention. As shown in FIG. 1, the system 100 comprises a mobile communication device 110 and a content aggregating apparatus 120. The mobile communication device 110 communicates with the content aggregating apparatus 120 via a mobile network 130. The content aggregating apparatus 120 can connect to the Internet 140. In addition, if the mobile communication device 110 is provided with satellite positioning functionality, a satellite 150 can provide the mobile communication device 110 with its location information, e.g. the latitude and longitude coordinates of the mobile communication device 110. The mobile communication device 110 is provided with an installed software program, which when executed can connect to a social network website 160 via the mobile network 130, the content aggregating apparatus 120 and the Internet 140.

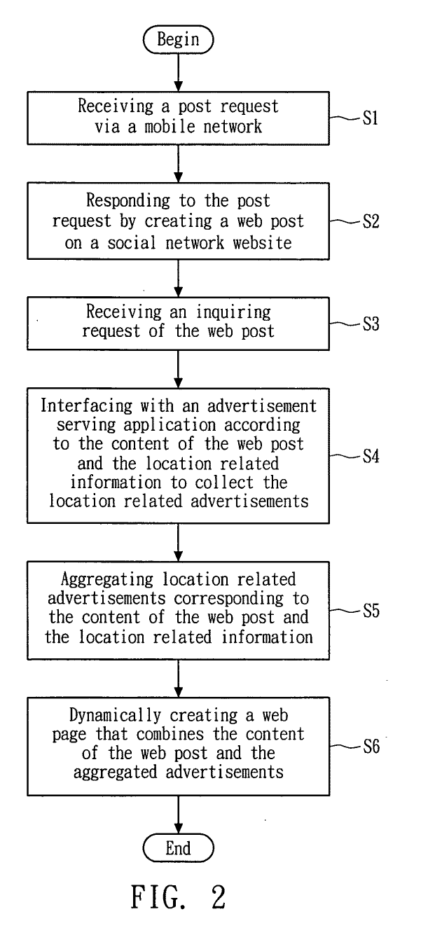

FIG. 2 shows a flow chart of a method for providing location aware social network service advertisements according to one embodiment of the present invention. In step S1, a post request from a mobile communication device is received by a content aggregating apparatus via a mobile network, wherein the post request comprises location-related information, and then step S2 is executed. In step S2, the content aggregating apparatus responds to the post request by creating a web post on a social network website, and then step S3 is executed. In step S3, the content aggregating apparatus receives an inquiring request from the web post, and then step S4 is executed. In step S4, the content aggregating apparatus interfaces with an advertisement serving application according to the content of the web post and the location-related information to collect location-related advertisements, and then step S5 is executed. In step S5, the content aggregating apparatus aggregates location-related advertisements corresponding to the content of the web post and the location-related information, and then step S6 is executed. In step S6, the content aggregating apparatus dynamically creates a web page that combines the content of the web post and the aggregated advertisements.

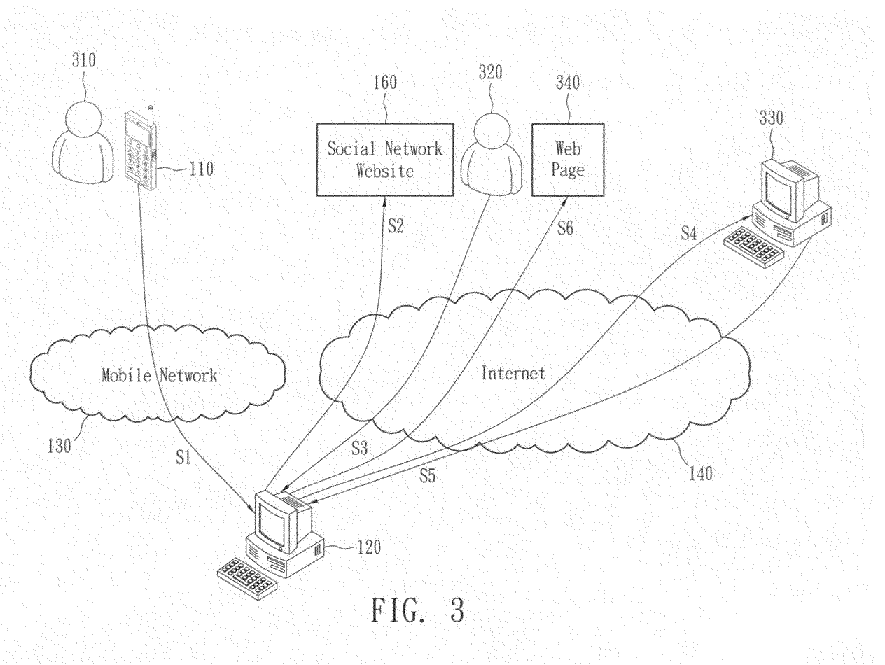

FIG. 3 shows an application of the method for providing location aware social network service advertisements shown in FIG. 2 to the system of providing location aware social network service advertisements shown in FIG. 1. The mobile communication device 110 is operated by a user 310. In this embodiment, the mobile communication device 110 can be a mobile phone, e.g. a Google Android mobile phone, and is installed with an application, e.g. ZeoLink application, which can provide a points of interest (POI) search by performing location based services (LBS). In this embodiment, the user 310 wants to share an event on the social network website 160, which may be Facebook, Twitter or Plurk in this embodiment, with his or her friend. The event contains location-related information. For example, the event may be the current location of the user 310 or a POI search result. The installed application allows the user 310 to view the social network website 160 on the mobile communication device 110, wherein the social network website 160 is displayed by a specific Internet browser provided by the installed application. The installed application can store the demographic information of the user 310. Accordingly, the user 310 can log into the social network website 160 directly.

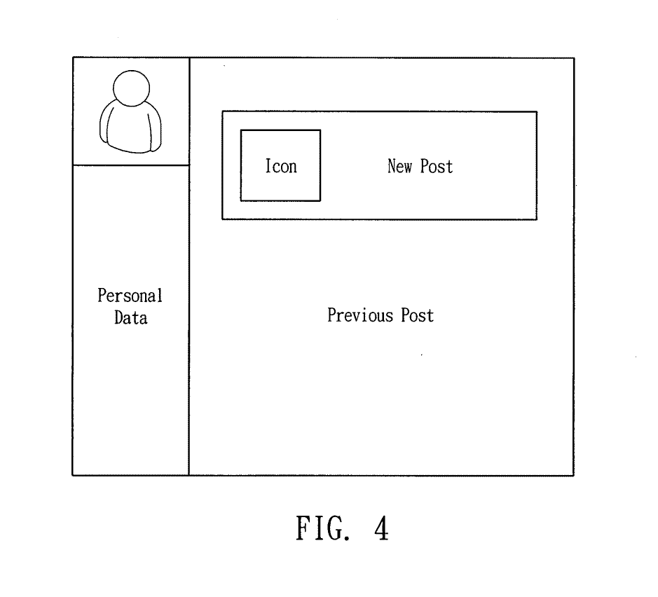

The following shows a combination of the flow in FIG. 2 and the application in FIG. 3. In step S1 of the flow in FIG. 2, a user 310 uses the mobile communication device 110 to deliver a post request. The content aggregating apparatus 120 then receives the request. In step S2, the content aggregating apparatus 120 responds to the post request by creating a web post on the social network website 160, wherein the web post comprises an object location graph and related information. In one embodiment, the user 310 wants to announce his location on the social network website 160. Accordingly, the web post containing a map of the nearby area of the user 310, which is represented by an icon, is posted on the social network website 160. In another embodiment, the user 310 wants to share POI information, such as information of a store or a restaurant, on the social network website 160. Accordingly, the web post containing a map of the nearby area of the POI and the information of the POI, such as a name, a telephone number or an address of the POI, is posted on the social network website 160. FIG. 4 shows a web post according to one embodiment of the present invention.

In step S3, an interested user 320, who may be a member of the social network website 160 and who operates a personal computer or any other communication device which can link to the social network website 160, inquires the web post by clicking on the icon of the web post. The content aggregating apparatus 120 then acknowledges the inquiring request of the web post. In step S4, the content aggregating apparatus 120 interfaces with an advertisement serving application 330 according to the content of the web post and the location-related information to collect location-related advertisements. The advertisement serving application 330 can perform an Internet search based on the location-related information and provide advertisements relevant to the searched content. In some embodiments, the advertisement serving application 330 is the Google AdSense application.

In step S5, the content aggregating apparatus 120 aggregates location-related advertisements corresponding to the content of the web post and the location-related information. In some embodiments, the aggregated location-related advertisements comprise the advertisements provided by the advertisement serving application 330 and advertisements provided by other advertisers. In step S6, the content aggregating apparatus dynamically creates a web page 340 that combines the content of the web post and the aggregated advertisements to provide the user 320 with further information.

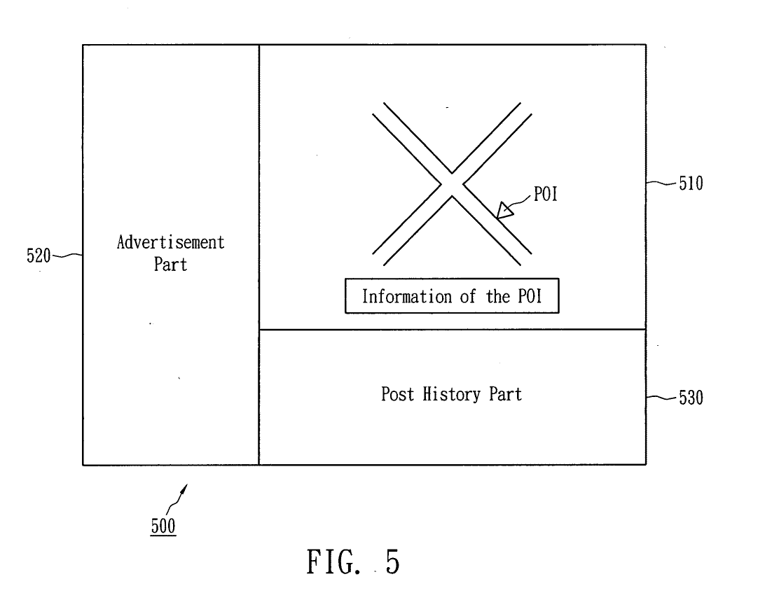

FIG. 5 shows a created web page according to one embodiment of the present invention. As shown in FIG. 5, the web page 500 comprises a web post part 510 illustrating the content of the web post. The web page 500 also comprises an advertisement part 520 providing the aggregated advertisements. Preferably, the web page 500 further comprises a post history part 530 recoding previous posts of the user 310 and the interaction of the user 310 with other users, such as a user 320. The post history part 530 also comprises a calendar for users to track post history. In addition, since the web page 500 is created dynamically, the content therein is updated accordingly. For example, the post history part 530 is updated each time the web page 500 is created such that the latest response can be viewed by the user inquiring the web post. The advertisement part 520 is also updated each time the web page 500 is created. The provided advertisements are rearranged according to the advertising policies, e.g. an obsolete advertisement may be removed from the advertisement part 520.

In conclusion, the method for providing location aware social network service advertisements of the present invention combines the advantages of mobile advertising and social network advertising. Specifically, a mobile communication device can provide location aware information, and a social network has many potential customers. Accordingly, by applying the method provided in this present invention, advertisers and advertising agencies can provide more personal related advertisements, i.e. information-related advertisements, to more interested consumers, i.e. members of a social network website.

The above-described embodiments of the present invention are intended to be illustrative only. Those skilled in the art may devise numerous alternative embodiments without departing from the scope of the following claims.

What is claimed is:

1. A method for providing location aware social network service advertisements, comprising the steps of:
receiving a post request via a mobile network, wherein the post request comprises location-related information;
responding to the post request by creating a web post on a social network website;
receiving an inquiring request of the web post;
aggregating location-related advertisements corresponding to the content of the web post and the location-related information; and
dynamically creating a web page that combines the content of the web post and the aggregated advertisements.

2. The method of claim 1, wherein the post request comprises points of interest (POI) search results.

3. The method of claim 2, wherein the POI search results are provided by the ZeoLink application.

4. The method of claim 2, wherein the web post comprises an object location graph and information of the POI.

5. The method of claim 4, wherein the object location graph includes an icon representing the POI and a map of the vicinity of the POI.

6. The method of claim 4, wherein the information includes a name, a telephone number or an address of the POI.

7. The method of claim 4, wherein the POI is a store or a restaurant.

8. The method of claim 1, further comprising the step of:
interfacing with an advertisement serving application according to the content of the web post and the location-related information to collect the location-related advertisements.

9. The method of claim 8, wherein the advertisement serving application is Google AdSense.

10. The method of claim 1, wherein the inquiring request is a click on the web post.

11. The method of claim 10, wherein the click is performed on an icon of the web post.

12. The method of claim 1, wherein the web page comprises a post history or a calendar recording previous posts.

13. The method of claim 12, wherein the post history and the calendar are updated according to the creation of the web page.

14. The method of claim 1, wherein the location-related advertisements are provided by advertisers.

15. The method of claim 1, wherein the post request is delivered by a user using a mobile communication device.

16. The method of claim 1, wherein the inquiring request is performed by a member of the social network website.

17. The method of claim 1, wherein the social network website is Facebook, Twitter or Plurk.
